(19) United States
(12) Patent Application Publication
(10) Pub. No.: US 2025/0155637 A1
(43) Pub. Date: May 15, 2025

(54) OPTICAL WAVEGUIDE ELEMENT, AND OPTICAL MODULATION DEVICE AND OPTICAL TRANSMISSION APPARATUS USING SAME

(71) Applicant: SUMITOMO OSAKA CEMENT CO., LTD., Tokyo (JP)

(72) Inventors: Yumi MURATA, Tokyo (JP); Junji ARAI, Tokyo (JP); Yuki KUGIMOTO, Tokyo (JP)

(73) Assignee: SUMITOMO OSAKA CEMENT CO., LTD., Tokyo (JP)

(21) Appl. No.: 18/840,692

(22) PCT Filed: Feb. 28, 2022
(86) PCT No.: PCT/JP2022/008391

§ 371 Date: Aug. 22, 2024

(51) Int. Cl. G02B 6/122; G02B 6/12; G02B 6/14; G02F 1/035

(52) U.S. Cl. CPC G02B 6/1228; G02B 6/14; G02F 1/035; G02B 2006/12097

(57) ABSTRACT

An object of the present invention is to provide an optical waveguide device capable of appropriately setting a positional relationship between an optical waveguide substrate and a reinforcing member. An optical waveguide device includes an optical waveguide substrate 11 provided with an optical waveguide 10; and a reinforcing member 2 disposed on an upper side of the optical waveguide near an end portion of the optical waveguide, the optical waveguide substrate and the reinforcing member being joined through an adhesive layer 3, in which spacers (SP1, SP2) are disposed between the optical waveguide substrate and the reinforcing member to interpose the optical waveguide between the spacers.

### TECHNICAL FIELD

The present invention relates to an optical waveguide device, and an optical modulation device and an optical transmission apparatus using the same and, particularly to an optical waveguide device including an optical waveguide substrate provided with an optical waveguide, and a reinforcing member disposed on an upper side of the optical waveguide near an end portion of the optical waveguide, the optical waveguide substrate and the reinforcing member being joined through an adhesive layer.

### BACKGROUND ART

In the field of optical measurement technology or in the field of optical communication technology, optical waveguide devices such as an optical modulator using a substrate on which an optical waveguide is formed and the like have been widely used. For example, the optical waveguide is formed by thermally diffusing Ti or the like on the substrate of lithium niobate (LN) or the like having an electro-optic effect. In the optical waveguide substrate on which the optical waveguide is formed, input light is introduced from the outside or output light is output to the outside. In order to introduce the input light from the outside into the optical waveguide on the substrate, an optical block such as an optical fiber, a lens, or the like is connected to an end surface of the substrate on which an input portion of the optical waveguide is formed. In addition, in order to appropriately output the output light, an optical block such as an optical fiber, a lens, polarization combining means, reflecting means, or the like is connected to an end surface of the substrate on which an output portion of the optical waveguide is formed.

In connecting the optical block to the optical waveguide substrate, a reinforcing member is fixed on the substrate along the end surface of the optical waveguide substrate using an adhesive (adhesive layer) in order to more firmly fix the optical block. Accordingly, the optical block is joined to two end surfaces of the optical waveguide substrate and the reinforcing member.

FIG. 1 is a plan view showing an example of an optical waveguide device and a part of the optical waveguide device. An optical waveguide 10 is formed in a protruding shape on a part of an LN substrate 1. In addition, since the thickness of the LN substrate 1 is extremely thin, that is, several μm or less, the LN substrate 1 is joined to a holding substrate 11 and fixed to the holding substrate 11. Hereinafter, an LN substrate including an optical waveguide and a holding substrate may be collectively referred to as an “optical waveguide substrate”.

In addition, in FIG. 1, a spot size converter 12 that changes a mode field diameter of a light wave propagating through the optical waveguide is disposed at an end portion of the optical waveguide, as disclosed in Patent Literatures 1 and 2. A spot size converter is also a part of the optical waveguide. A reinforcing member 2, shown by a dotted line, is disposed to be overlapped on the optical waveguide substrate near an end portion of the optical waveguide substrate 11.

FIG. 2 shows a cross section view taken along an alternate long and short dash line A-A′ in FIG. 1. In FIG. 2, the reinforcing member 2 is not disposed in a normal state with respect to the optical waveguide substrate 11 (both are parallel), but is fixed in an inclined state. An adhesive (adhesive layer) 3 is provided between the optical waveguide substrate 11 and the reinforcing member 2. As shown in FIG. 2, in a case where the reinforcing member is disposed at an inclined state or the reinforcing member 2 and the optical waveguide (spot size converter 12 in FIG. 2) are disposed with a distance closer than a predetermined interval, the mode field diameter of the light wave propagating through the optical waveguide may vary. As a result, optical loss occurs at input and output portions of the optical waveguide device. In addition, in a case where a thickness of the adhesive layer (in a Z direction of FIG. 2) is uneven, the peeling of the reinforcing member may be caused.

In addition, as shown in FIG. 3, a termination substrate TS is disposed adjacent to the optical waveguide substrate 1 (11), and wiring formed on the optical waveguide substrate and a termination resistor of the termination substrate TS are connected by wire bonding WI. For example, an interval L between the optical waveguide substrate and the termination substrate is about 40 μm. The optical waveguide substrate 1 and the termination substrate TS are accommodated in a case CA. A misalignment (in XY directions) of a connection position of the reinforcing member 2 with respect to the optical waveguide substrate 1 (11) causes contamination of electrodes due to the adhesive or positional interference between the reinforcing member 2 and the termination substrate TS. These factors cause degradation in characteristics of the optical waveguide device, including degradation of an electrical bandwidth of a high-frequency signal. Therefore, it is required to perform an accurate alignment between the optical waveguide substrate and the reinforcing member in XYZ directions as shown in FIGS. 1 to 3.

### CITATION LIST

### Patent Literature

[Patent Literature No. 1] Japanese Patent Application No. 2021-058675 (filed on Mar. 30, 2021)
[Patent Literature No. 2] International Application No. PCT/JP2021/36276 (filed on Sep. 30, 2021)

### SUMMARY OF INVENTION

### Technical Problem

An object to be achieved by the present invention is to address the aforementioned issues and to provide an optical waveguide device capable of appropriately setting a positional relationship between an optical waveguide substrate and a reinforcing member. In addition, the object is to provide an optical modulation device and an optical transmission apparatus using the optical waveguide device.

### Solution to Problem

In order to achieve the object, the optical waveguide device of the present invention, and the optical modulation device and the optical transmission apparatus using the same have the following technical features.

(1) An optical waveguide device includes: an optical waveguide substrate provided with an optical waveguide; and a reinforcing member disposed on an upper side of the optical waveguide near an end portion of the optical waveguide, the optical waveguide substrate and the reinforcing member being joined through an adhesive layer, in which spacers are disposed between the optical waveguide substrate and the reinforcing member to interpose the optical waveguide between the spacers.

(2) In the optical waveguide device according to (1), the spacer also serves as positioning means in a direction parallel to a plane in which the optical waveguide substrate and the reinforcing member face each other.

(3) In the optical waveguide device according to (1) or (2), the spacer includes two parts, and one part is formed on the optical waveguide substrate and another part is formed on the reinforcing member.

(4) In the optical waveguide device according to (2), the positioning means includes a marker for positioning the spacer, and any one of the optical waveguide substrate and the reinforcing member includes the marker.

(5) In the optical waveguide device according to (1) or (2), a position at which the spacer is disposed with respect to the reinforcing member is a location separated from an end surface of the reinforcing member, in which the end portion of the optical waveguide is positioned, by ¼ or more than a length of the reinforcing member in a light propagation direction.

(6) In the optical waveguide device according to (1) or (2), the spacer is a film body formed on the reinforcing member or the optical waveguide substrate, or a protruding portion formed by mechanically processing the reinforcing member or the optical waveguide substrate.

(7) In the optical waveguide device according to (1) or (2), a distance between the optical waveguide and the reinforcing member is set in a range of 0.2 times to 1.5 times a mode field diameter of the optical waveguide.

(8) In the optical waveguide device according to (1) or (2), a spot size converter that changes a mode field diameter of a light wave propagating through the optical waveguide is disposed in the optical waveguide positioned on a lower side of the reinforcing member.

(9) An optical modulation device includes: the optical waveguide device according to (1) or (2); a case accommodating the optical waveguide device; and an optical fiber through which a light wave is input into the optical waveguide or output from the optical waveguide.

(10) In the optical modulation device according to (9), the optical waveguide device includes a modulation electrode for modulating the light wave propagating through the optical waveguide, and an electronic circuit that amplifies a modulation signal to be input into the modulation electrode of the optical waveguide device is provided inside the case.

(11) An optical transmission apparatus includes: the optical modulation device according to (9) or (10); and an electronic circuit that outputs a modulation signal causing the optical modulation device to perform a modulation operation.

### Advantageous Effects of Invention

In the present invention, since an optical waveguide device includes: an optical waveguide substrate provided with an optical waveguide; and a reinforcing member disposed on an upper side of the optical waveguide near an end portion of the optical waveguide, the optical waveguide substrate and the reinforcing member being joined through an adhesive layer, in which spacers are disposed between the optical waveguide substrate and the reinforcing member to interpose the optical waveguide between the spacers, it is possible to maintain an interval between the optical waveguide substrate and the reinforcing member at an appropriate position.

In addition, since the spacer also serves as positioning means in a direction parallel to a plane in which the optical waveguide substrate and the reinforcing member face each other, it is possible to reduce a misalignment of positions of both in the parallel direction.

Furthermore, it is possible to provide an optical modulation device and an optical transmission apparatus using the optical waveguide device.

### BRIEF DESCRIPTION OF DRAWINGS

FIG. 1 is a plan view showing an optical waveguide device according to the related art.

FIG. 2 is a cross section view taken along an alternate long and short dash line A-A′ in FIG. 1.

FIG. 3 is a diagram for describing a positional relationship between an optical waveguide substrate and a termination substrate constituting an optical waveguide device.

FIG. 4 is a plan view showing an example of an optical waveguide device according to the present invention.

FIG. 5 is a cross section view taken along an alternate long and short dash line B-B′ in FIG. 4.

FIG. 6 is another cross section view taken along the alternate long and short dash line B-B′ in FIG. 4.

FIG. 7 is a plan view showing another example of the optical waveguide device according to the present invention.

FIG. 8 is a cross section view taken along an alternate long and short dash line C-C′ in FIG. 7.

FIG. 9 is a plan view showing an example of a reinforcing member used in the present invention.

FIG. 10 is a cross section view taken along an alternate long and short dash line D-D′ in FIG. 9.

FIG. 11 is a plan view showing another example of the reinforcing member used in the present invention.

FIG. 12 is a cross section view taken along an alternate long and short dash line E-E′ in FIG. 11.

FIG. 13 is a plan view showing an example of an optical waveguide substrate used in the present invention.

FIG. 14 is a cross section view taken along an alternate long and short dash line F-F′ in FIG. 13.

FIG. 15 is a plan view showing another example of the optical waveguide device according to the present invention.

FIG. 16 is a cross section view taken along an alternate long and short dash line G-G′ in FIG. 15.

FIG. 17 is a plan view showing another example of the optical waveguide substrate used in the present invention.

FIG. 18 is a cross section view taken along an alternate long and short dash line H-H′ in FIG. 17.

FIG. 19 is a plan view showing a state in which a reinforcing member is overlapped on the optical waveguide substrate of FIG. 17.

FIGS. 20A and 20B are diagrams showing a state in which the optical waveguide substrate and the reinforcing member are joined to each other before being cut into a chip of the optical waveguide device, in which FIG. 20A is a plan view and FIG. 20B is a cross section view.

FIGS. 21A and 21B are diagrams showing a state in which the cutting is performed in the state of FIGS. 20A and 20B and a chip of the optical waveguide device is formed, in which FIG. 21A is a plan view and FIG. 21B is a cross section view.

FIG. 22 is a plan view showing another example of the optical waveguide device of the present invention.

FIG. 23 is a cross section view taken along an alternate long and short dash line K-K′ in FIG. 22.

FIG. 24 is a cross section view showing another example of the optical waveguide device of the present invention.

FIG. 25 is a plan view for describing an optical modulation device and an optical transmission apparatus using the optical waveguide device of the present invention.

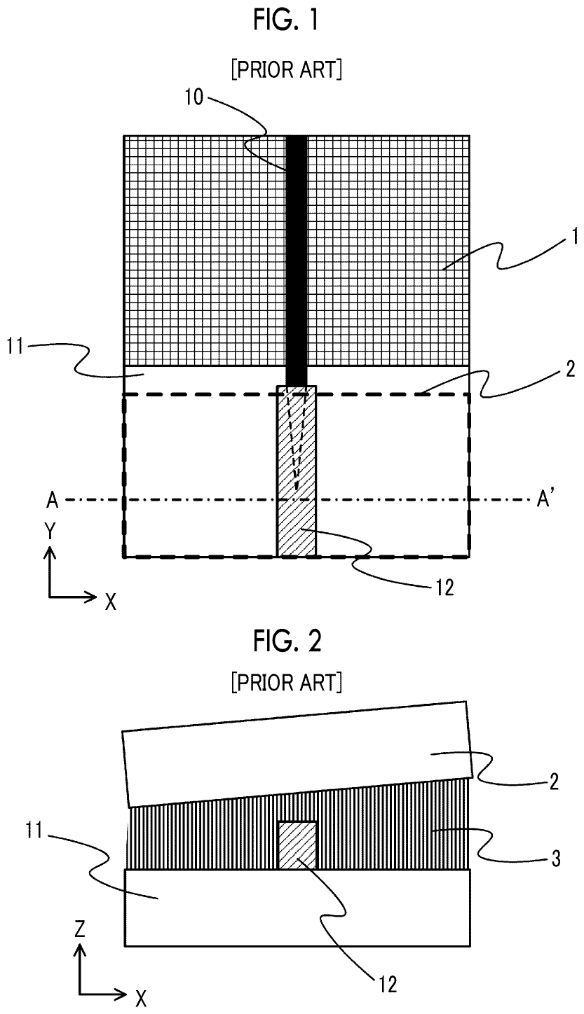

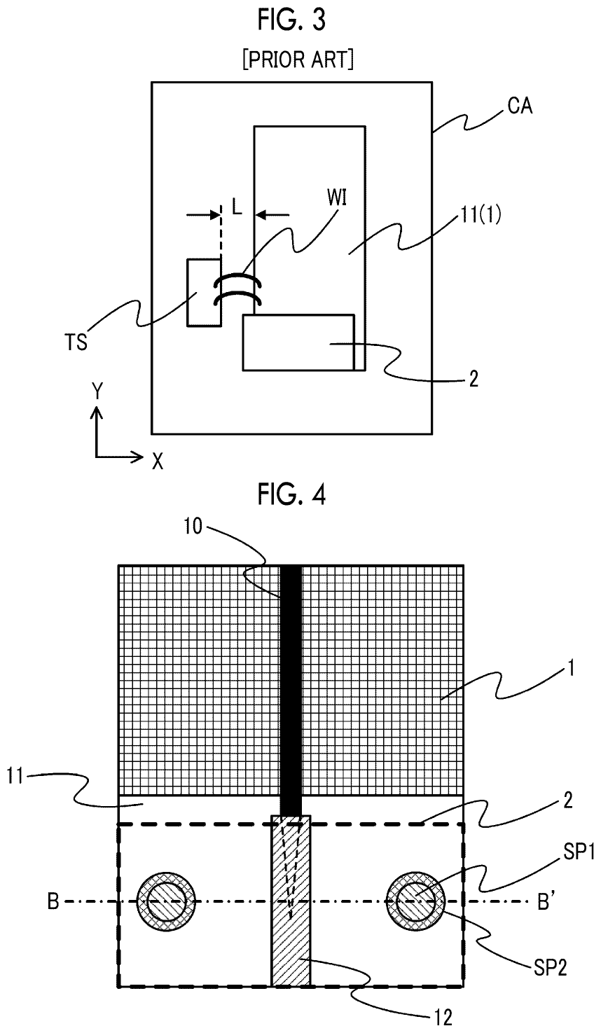

### DESCRIPTION OF EMBODIMENTS

Hereinafter, an optical waveguide device of the present invention will be described in detail using preferred examples.

As shown in FIGS. 4 to 25, an optical waveguide device of the present invention includes an optical waveguide substrate 1 (11) provided with an optical waveguide 10 (12), and a reinforcing member 2 disposed on an upper side of the optical waveguide near an end portion of the optical waveguide, the optical waveguide substrate and the reinforcing member being joined through an adhesive layer 3, in which spacers SP (SP1 and SP2) are disposed between the optical waveguide substrate and the reinforcing member to interpose the optical waveguide between the spacers.

In addition, the spacer SP also serves as positioning means in a direction parallel to a plane in which the optical waveguide substrate 1 (11) and the reinforcing member 2 face each other.

As the optical waveguide substrate 1 used in the optical waveguide device of the present invention, materials having an electro-optic effect such as a substrate formed of lithium niobate (LN), lithium tantalate (LT), lead lanthanum zirconate titanate (PLZT), or the like, or a vapor-phase growth film formed of these materials.

In addition, various materials such as semiconductor materials, organic materials, or the like can also be used as the optical waveguide.

Furthermore, the “optical waveguide substrate” in the present invention is a concept including not only the substrate having the electro-optic effect but also a “holding substrate” described later.

As a method of forming the optical waveguide 10, a method of forming the optical waveguide 10 by thermally diffusing Ti or the like on an LN substrate or of forming a rib optical waveguide by causing a part corresponding to the optical waveguide to have a protruding shape on a substrate by, for example, etching a part of the substrate 1 other than the optical waveguide or by forming grooves on both sides of the optical waveguide can be used. Furthermore, a refractive index can be further increased by diffusing Ti or the like on a surface of the substrate using a thermal diffusion method, a proton exchange method, or the like in accordance with the rib optical waveguide. While the following description will be mainly made with reference to the rib optical waveguide 10 and a spot size converter 12, the same idea also applies to other optical waveguides having a protruding part, such as a Ti diffused waveguide or the like.

A thickness of the substrate (thin plate) on which the optical waveguide 10 is formed is set to be 10 μm or lower, more preferably 5 μm or lower, and still more preferably 1 μm or lower in order to achieve velocity matching between a microwave of a modulation signal and a light wave. In addition, a height of the rib optical waveguide is set to be 4 μm or lower, more preferably 3 μm or lower, and still more preferably 1 μm or lower or 0.4 μm or lower. In addition, it is also possible to form a vapor-phase growth film on the holding substrate 11 and to process the film to have a shape of the optical waveguide.

The substrate 1 on which the optical waveguide is formed is adhesively fixed to the holding substrate 11 via direct joining or through an adhesive layer of resin or the like in order to increase mechanical strength. As the holding substrate 11 to be directly joined, a substrate including an oxide layer of a material such as crystal, glass, sapphire, or the like that has a lower refractive index than those of the optical waveguide and the substrate on which the optical waveguide is formed, and that has a similar coefficient of thermal expansion to the optical waveguide or the like is preferably used. Composite substrates obtained by forming a silicon oxide layer on a silicon substrate and by forming a silicon oxide layer on an LN substrate, which are abbreviated to SOI and LNOI, can also be used.

The “optical waveguide substrate” in the present invention is a concept including not only the “optical waveguide” and the “substrate on which the optical waveguide is formed” but also the “holding substrate”.

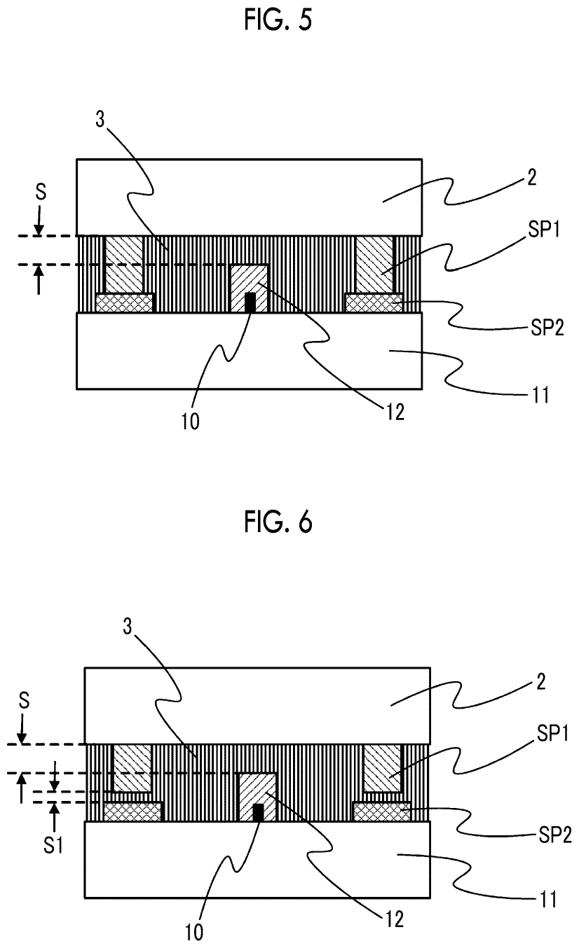

In a case where a height of the optical waveguide 10 is 1 μm or lower, a block body 12 of a spot size converter is formed as shown in FIGS. 4 and 5. The spot size converter applied to the optical waveguide device of the present invention is not limited to these and may be a so-called taper-shaped spot size converter in which the width or height of the optical waveguide gradually increases toward an end portion of the substrate. Here, a configuration is shown in which the spot size converter has the rib optical waveguide 10 with a tapered shape where a width of a distal end is reduced, and a block portion 12 serving as a core portion is disposed to surround the distal end.

In the optical waveguide device of the present invention, the reinforcing member 2 is disposed on the upper side of the optical waveguide (rib optical waveguide 10) or the spot size converter 12. A material having approximately the same refractive index and the same linear expansion coefficient as the holding substrate 11 is used in the reinforcing member 2. In a case where linear expansion coefficients match, a problem such as detachment of the reinforcing member (upper substrate) because of thermal stress or the like can be reduced, and an optical waveguide device having excellent thermostability is obtained. An adhesive formed of UV curable resin, resin such as acryl-based resin or epoxy-based resin, or the like can be used in the adhesive (adhesive layer) 3 with which the reinforcing member 2 is joined to the optical waveguide substrate 1 or to the holding substrate 11.

A feature of the optical waveguide device of the present invention is that the spacers SP (SP1 and SP2) is disposed between the optical waveguide substrate 1 (11) and the reinforcing member 2 to interpose the optical waveguide 10 (12) between the spacers SP. In addition, the spacer SP also serves as positioning means in the direction parallel to the plane in which the optical waveguide substrate 1 (11) and the reinforcing member 2 face each other.

Specifically, as shown in FIGS. 4 and 5, SP1 is provided on one part that forms the spacer of the reinforcing member 2, and SP2 is formed on another part that forms the spacer in the optical waveguide substrate 11. As shown in FIG. 5, the spacer includes two parts (SP1 and SP2), and one part is formed on the optical waveguide substrate and another part is formed on the reinforcing member. In addition, as will be described later, a single member can also form the spacer.

FIG. 5 is a cross section view taken along an alternate long and short dash line B-B′ in FIG. 4, and the two members (SP1 and SP2) forming the spacer are closely attached to each other. In order to realize such a configuration, the optical waveguide substrate 11 and the reinforcing member 2 are overlapped with each other, and the highly fluid adhesive 3 is introduced into the gap between both via capillary action. FIG. 6 shows a state in which the adhesive 3 is applied to any one of the optical waveguide substrate 11 and the reinforcing member 2, and both are bonded together. In such a case, a gap S1 is generated between the two members (SP1 and SP2) that form the spacer.

The gap S1 can be set to 0 μm to 3 μm, but it is desirable to set the gap S1 to 0 μm to 1 μm in order to stably fix the reinforcing member 2. In addition, in a case where the gap S1 is not 0 μm, the adhesive 3 flows into the gap S1. Further, adjustment of the gap S1 can be achieved by adjusting a pressing pressure of the reinforcing member 2 on the optical waveguide substrate 11.

As shown in FIG. 5 or 6, in a state in which the optical waveguide substrate and the reinforcing member are bonded together, a distance S between the optical waveguide (the spot size converter 12 in the drawing) and the reinforcing member 2 is generated. In a case where the distance is short, the refractive indices of the adhesive and the reinforcing member differ, causing a change in the mode field diameter of a light wave propagating through the optical waveguide. In addition, when the distance S is increased, the thickness of the adhesive layer increases, and a difference between a thermal expansion coefficient of the optical waveguide substrate or the reinforcing member and a thermal expansion coefficient of the adhesive causes local internal stress, leading to a change in the refractive index of the optical waveguide.

Therefore, from the viewpoint of reducing the change in the mode field diameter and the change in the refractive index of the optical waveguide, it is preferable that the distance S is set in a range of 0.2 times to 1.5 times the mode field diameter (MFD) of the light wave propagating through the optical waveguide. In addition, although the influence of thermal expansion increases, the distance S may be set to be larger than 1.5 times the mode field diameter.

As described above, the spacers (SP1 and SP2) play a role in appropriately maintaining the interval between the optical waveguide substrate and the reinforcing member. The spacer used in the present invention also serves as positioning means in the direction parallel to the plane in which the optical waveguide substrate and the reinforcing member face each other. Specifically, as shown in FIG. 4, the spacers SP1 and SP2 are disposed such that the spacers SP1 and SP2 are overlapped with each other in a concentric circle shape, thereby performing the positioning in a plane direction (up, down, left, and right directions in the drawing) shown in FIG. 4.

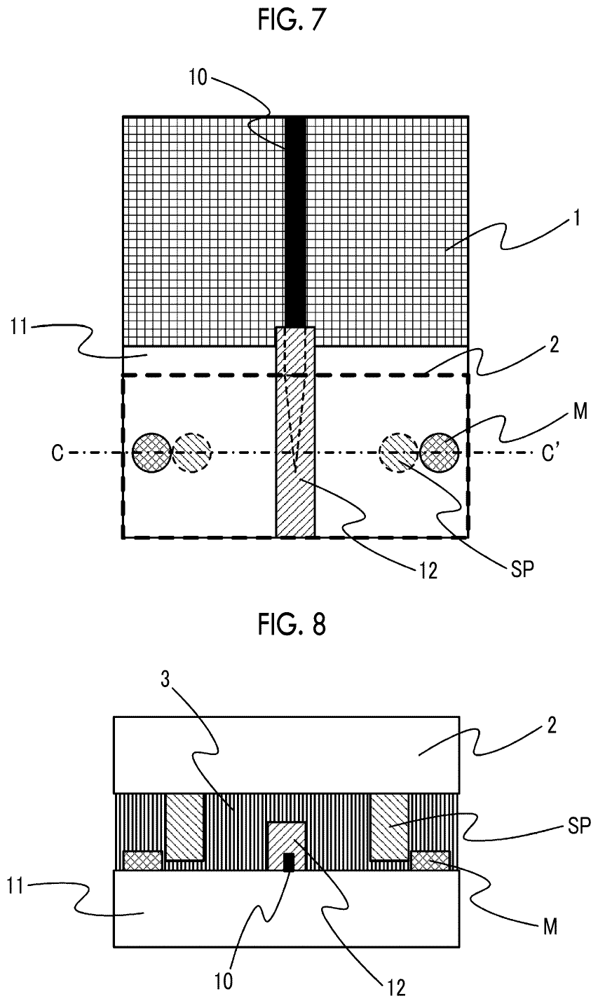

FIGS. 7 and 8 are other examples of the optical waveguide device of the present invention. Only a part SP provided on the reinforcing member 2 functions as a spacer. A protrusion M provided on the optical waveguide substrate 11 functions not as a spacer but as a marker for positioning the spacer. It is also possible to provide the spacer SP on the optical waveguide substrate and to form the marker M on the reinforcing member.

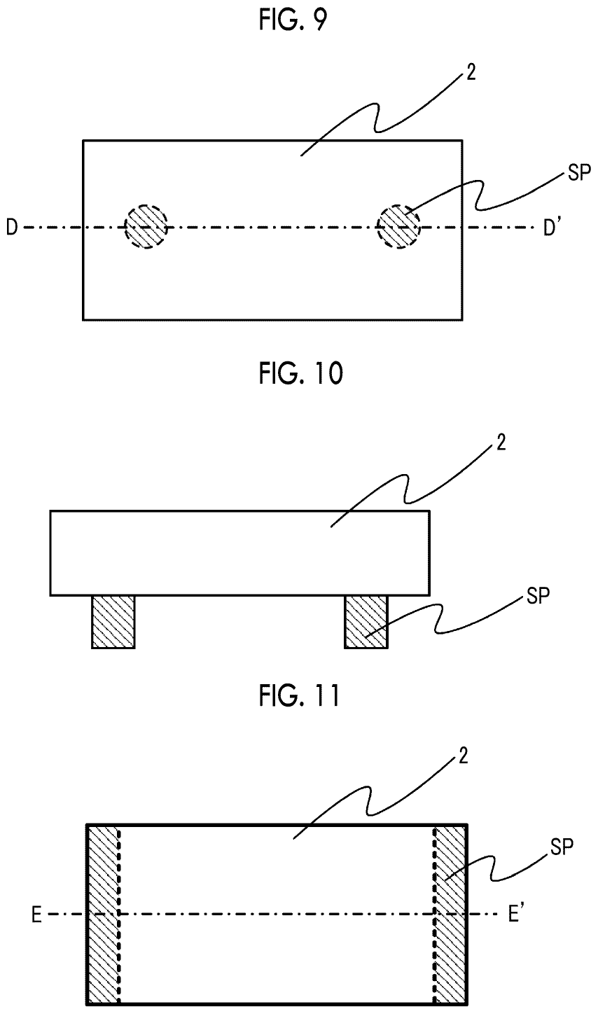

As a method of manufacturing the spacer, as shown in FIG. 9 and FIG. 10 (a cross section view taken along an alternate long and short dash line D-D′ in FIG. 9), the protrusion SP can be formed on a surface of the reinforcing member 2 via a permanent resist (photosensitive insulating film) using a photoresist film. In this case, the number of protrusions is not limited to two as shown in FIG. 9, and a plurality of protrusions, numbering two or more, can be formed. In addition, by setting a total area occupied by the protrusions to 1% or less, more preferably 0.1% or less, with respect to an area of the surface of the reinforcing member on which the protrusions are formed, it is possible to easily spread the adhesive and improve an escape of air bubbles contained in the adhesive.

As resin used in the permanent resist, various materials such as polyamide-based resin, melamine-based resin, phenol-based resin, amino-based resin, epoxy-based resin, and the like can be used.

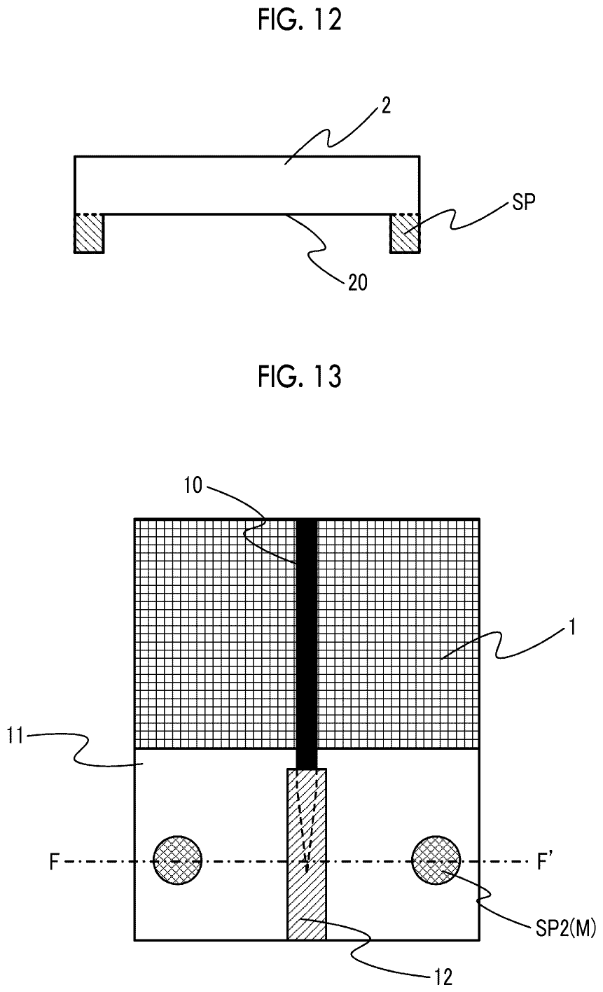

In addition, regarding the spacer, as shown in FIG. 11 and FIG. 12 (a cross section view taken along an alternate long and short dash line E-E′ in FIG. 11), the spacer SP may be formed by removing a part of the reinforcing member 2 via a mechanical process such as dicing, dry etching, or the like and leaving the remaining part, or the spacer SP may be formed of a permanent resist. In this case, a total area occupied by the protrusions can be 10% or more with respect to the area of the surface of the reinforcing member on which the protrusions are formed, but it is desirable to be 50% or more from the viewpoint of ensuring visibility of a raised portion during assembly and ensuring the mechanical strength of the reinforcing member 2. It is even more desirable when the total area is 70% or more.

Further, in a case where the dicing process is performed, a surface 20 becomes rough after cutting, thereby making it possible to expect an effect of capturing air bubbles in the adhesive on the surface and separating the air bubbles from the optical waveguide.

Regarding the reinforcing member, each reinforcing member can be formed by forming a part to be a spacer in advance on a single wafer substrate, and then cutting the wafer substrate to separate the reinforcing member.

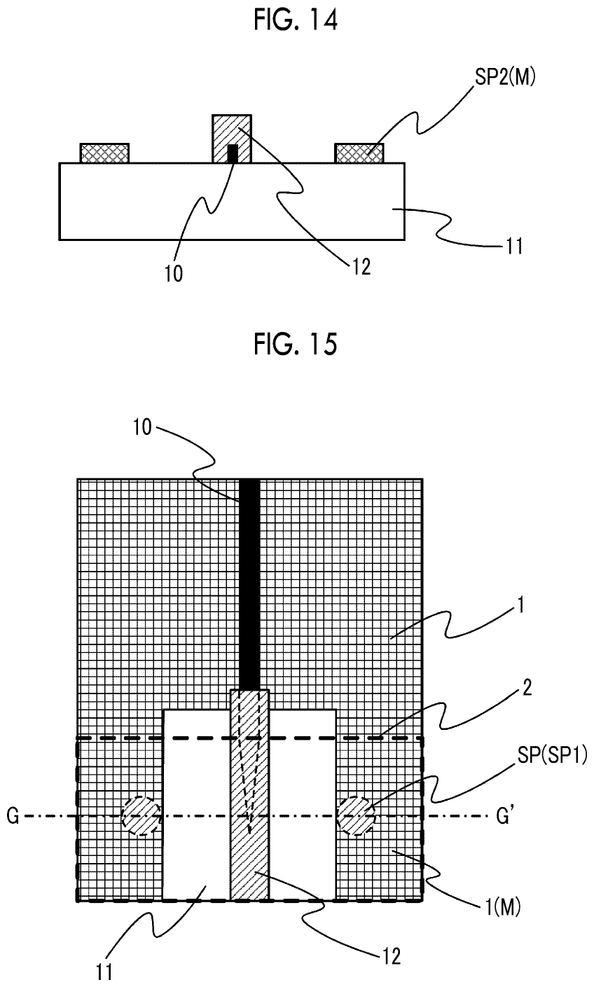

As shown in FIG. 13 and FIG. 14 (a cross section view taken along an alternate long and short dash line F-F′ in FIG. 13), the spacer SP2 or the marker M is formed on the optical waveguide substrate 11. The spacer SP2 (marker M) can also be formed using a permanent resist or a protrusion formed via the mechanical process, as in the reinforcing member. In addition, for example, the spacer SP2 (marker M) can be formed using materials used in the process of forming the optical waveguide device, such as Au or the like used for an electrode. Further, a permanent resist or the like used when forming the spot size converter may be used. The optical waveguide substrate shown in FIGS. 13 and 14 can be used, for example, as shown in FIG. 4 or FIG. 7.

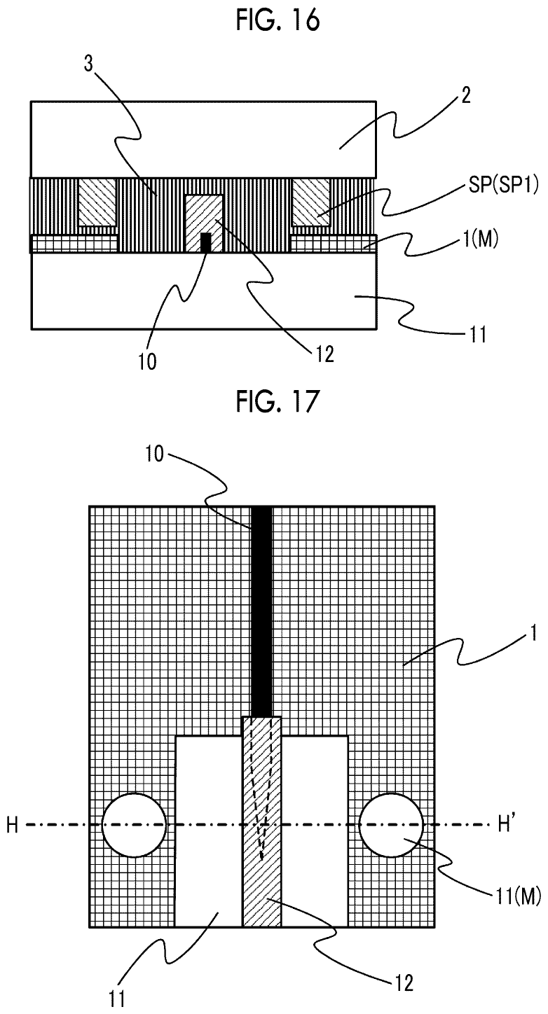

Further, as shown in FIG. 15 and FIG. 16 (a cross section view taken along an alternate long and short dash line G-G′ in FIG. 15), the spacer or the marker can be formed by using a part 1 (M) of the substrate 1 where the optical waveguide 10 is not formed. For example, as shown in FIG. 15, the spacer SP (SP1) formed on the reinforcing member 2 is disposed to be aligned with an edge of the part 1 (M) where the substrate 1 remains, so that the reinforcing member 2 can be accurately disposed with respect to the optical waveguide substrate 1 (11).

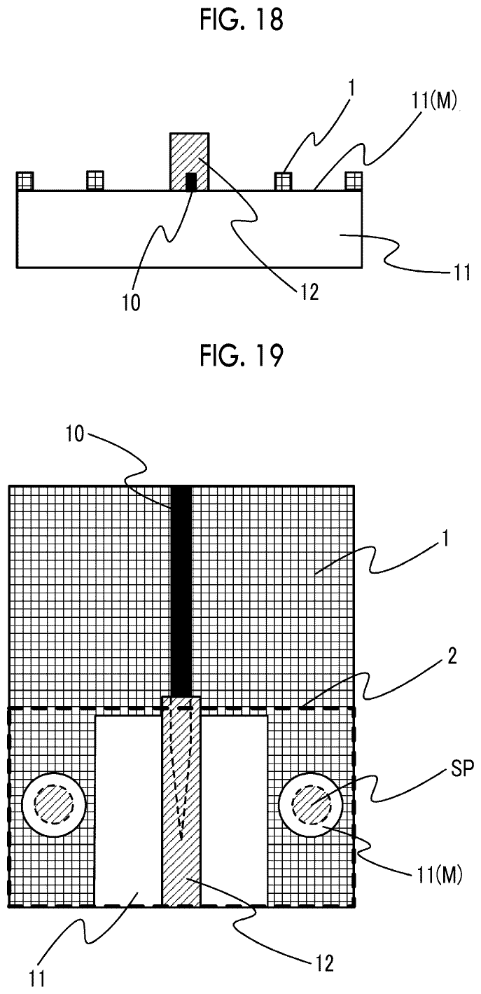

In addition, as shown in FIG. 17 and FIG. 18 (a cross section view taken along an alternate long and short dash line H-H′ in FIG. 17), an opening portion serving as the marker M may be provided in a part of the substrate 1. In this case, as shown in FIG. 19, the spacer SP of the reinforcing member 2 is disposed at the marker M of the opening portion.

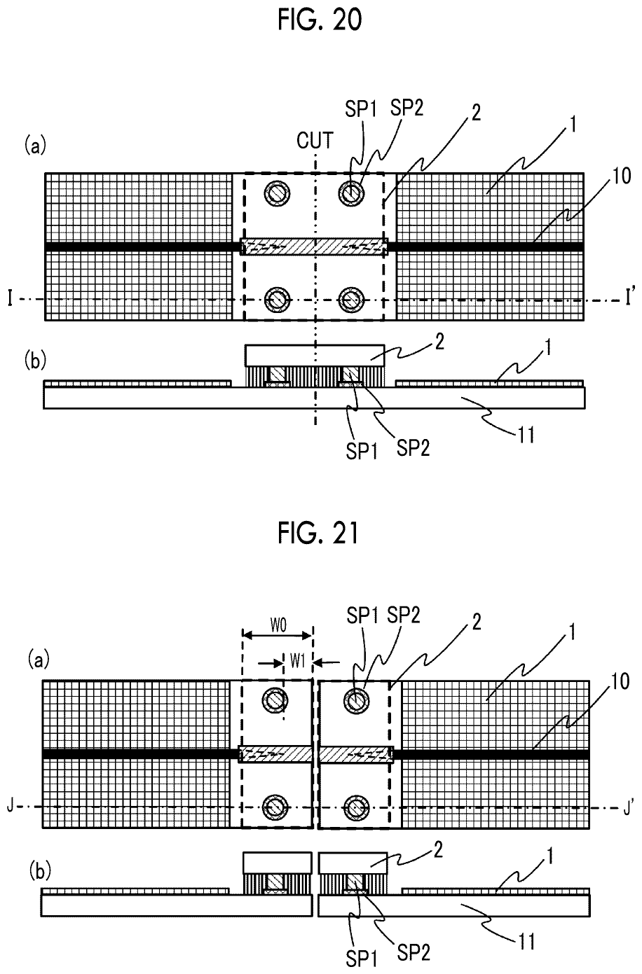

Next, a position at which the spacer provided in the reinforcing member is disposed will be described. When the reinforcing member is bonded to the optical waveguide substrate, as an example, as shown in FIGS. 20A and 20B, the reinforcing member 2 can be bonded in a state in which two optical waveguide devices are connected to each other. When a plurality of optical waveguide devices are formed on a single wafer and the wafer is cut into a chip shape, a state in which two optical waveguide devices are connected to each other as in FIGS. 20A and 20B can be obtained. FIG. 20A is a plan view, and FIG. 20B is a cross section view taken along an alternate long and short dash line I-I′ in FIG. 20A.

When the reinforcing member 2 in FIGS. 20A and 20B is disposed on the optical waveguide substrate 1 (11), the reinforcing member 2 can be more stably attached when the positions of the spacers disposed on the reinforcing member 2 are separated from each other. A state in which the wafer is cut along a two-dot chain line (CUT) in FIGS. 20A and 20B is shown in FIGS. 21A and 21B. A distance W1 from an end surface (cut surface) of the reinforcing member 2, in which the end portion of the optical waveguide is positioned, to the spacer SP1 is set to be ¼ or more, more preferably ½ or more than a length W0 of the reinforcing member in a light propagation direction (a left-right direction in the drawing). That is, the spacer SP1 is not formed in a range of less than ¼×W0 or less than ½×W0 from the cut surface.

In the optical waveguide device of the present invention, as shown in Patent Literature No. 1 or 2, it is possible to additionally adopt a configuration for keeping the air bubbles contained in the adhesive away from the optical waveguide 10 or the spot size converter 12.

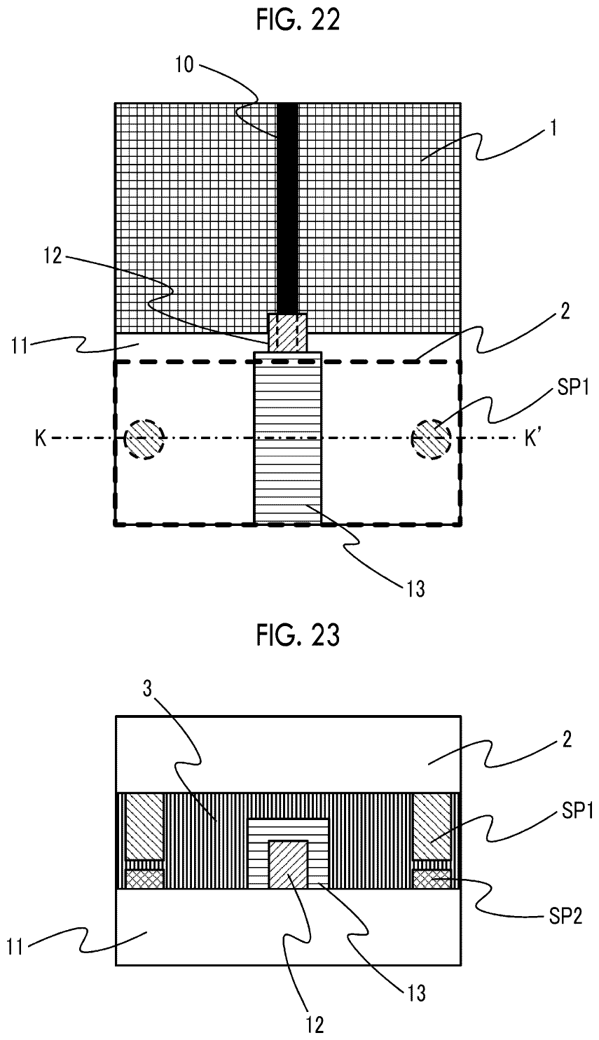

As shown in FIG. 22 and FIG. 23 (a cross section view taken along an alternate long and short dash line K-K′ in FIG. 22), a configuration is adopted, in which a protective layer 13 made of a material with a lower refractive index than the refractive index of the optical waveguide (spot size converter) is provided to surround the optical waveguide (spot size converter 12), ensuring that air bubbles do not approach the vicinity of the optical waveguide.

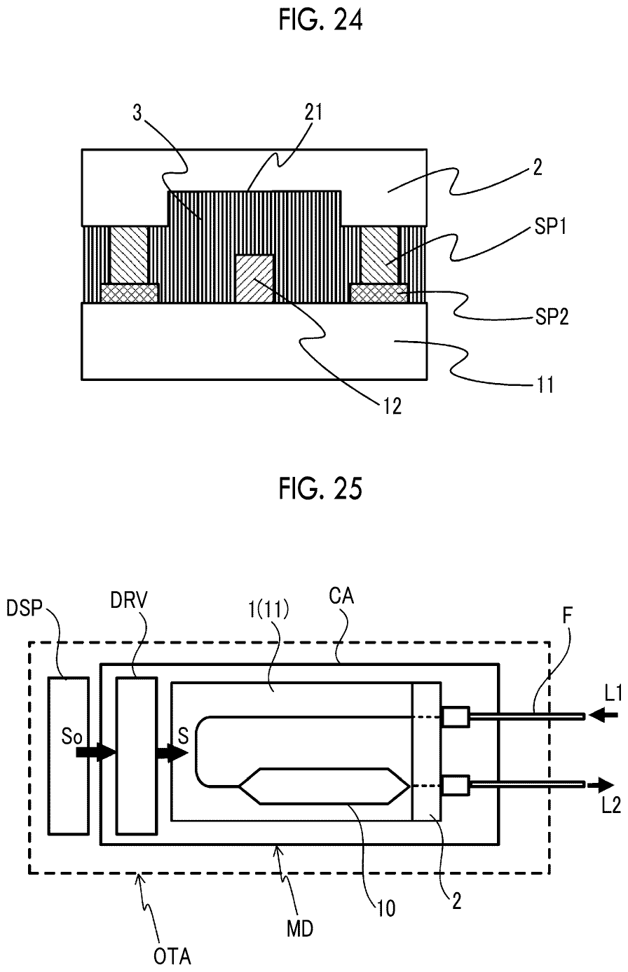

In addition, as shown in a cross section view in FIG. 24, it is also possible to perform a deeper dicing process on a part of the reinforcing member 2 and to enclose the air bubbles in the vicinity of a processed surface 21. It is also possible to enhance the effect of capturing air bubbles with roughness of the processed surface 21.

The optical waveguide device of the present invention is provided with a modulation electrode that modulates the light wave propagating through the optical waveguide 10 in the optical waveguide substrate 1 (11) and is accommodated inside a case CA as shown in FIG. 25. Furthermore, an optical modulation device MD can be configured by providing an optical fiber (F) through which the light wave is input into the optical waveguide or output from the optical waveguide. In FIG. 25, the optical fiber is introduced into the case through a through-hole that penetrates a side wall of the case, and is directly joined to the optical waveguide device. The optical waveguide device and the optical fiber can also be optically connected through a space optical system.

An optical transmission apparatus OTA can be configured by connecting, to the optical modulation device MD, an electronic circuit (digital signal processor DSP) that outputs a modulation signal S₀ causing the optical modulation device MD to perform a modulation operation. A modulation signal S to be applied to the optical waveguide device is required to be amplified. Thus, a driver circuit DRV is used. The driver circuit DRV and the digital signal processor DSP can be disposed outside the case CA or can be disposed inside the case CA. Particularly, disposing the driver circuit DRV inside the case can further reduce propagation loss of the modulation signal from the driver circuit.

### INDUSTRIAL APPLICABILITY

As described above, according to the present invention, it is possible to provide an optical waveguide device capable of appropriately setting a positional relationship between an optical waveguide substrate and a reinforcing member. In addition, it is possible to provide an optical modulation device and an optical transmission apparatus using the optical waveguide device.

### REFERENCE SIGNS LIST

1: substrate (thin plate, film body) on which optical waveguide is formed
2: reinforcing member
3: adhesive (adhesive layer)
10: rib optical waveguide
11: holding substrate (part of optical waveguide substrate)
12: block body (part of spot size converter)
13: protective layer
SP, SP1, SP2: spacer
M: marker

1. An optical waveguide device comprising:
an optical waveguide substrate provided with an optical waveguide; and
a reinforcing member disposed on an upper side of the optical waveguide near an end portion of the optical waveguide, the optical waveguide substrate and the reinforcing member being joined through an adhesive layer,
wherein spacers are disposed between the optical waveguide substrate and the reinforcing member to interpose the optical waveguide between the spacers.

2. The optical waveguide device according to claim 1,
wherein the spacer also serves as positioning means in a direction parallel to a plane in which the optical waveguide substrate and the reinforcing member face each other.

3. The optical waveguide device according to claim 1,
wherein the spacer includes two parts, and
one part is formed on the optical waveguide substrate and another part is formed on the reinforcing member.

4. The optical waveguide device according to claim 2,
wherein the positioning means includes a marker for positioning the spacer, and
any one of the optical waveguide substrate and the reinforcing member includes the marker.

5. The optical waveguide device according to claim 1,
wherein a position at which the spacer is disposed with respect to the reinforcing member is a location separated from an end surface of the reinforcing member, in which the end portion of the optical waveguide is positioned, by ¼ or more than a length of the reinforcing member in a light propagation direction.

6. The optical waveguide device according to claim 1,
wherein the spacer is a film body formed on the reinforcing member or the optical waveguide substrate, or a protruding portion formed by mechanically processing the reinforcing member or the optical waveguide substrate.

7. The optical waveguide device according to claim 1,
wherein a distance between the optical waveguide and the reinforcing member is set in a range of 0.2 times to 1.5 times a mode field diameter of the optical waveguide.

8. The optical waveguide device according to claim 1,
wherein a spot size converter that changes a mode field diameter of a light wave propagating through the optical waveguide is disposed in the optical waveguide positioned on a lower side of the reinforcing member.

9. An optical modulation device comprising:
the optical waveguide device according to claim 1;
a case accommodating the optical waveguide device; and
an optical fiber through which a light wave is input into the optical waveguide or output from the optical waveguide.

10. The optical modulation device according to claim 9,
wherein the optical waveguide device includes a modulation electrode for modulating the light wave propagating through the optical waveguide, and
an electronic circuit that amplifies a modulation signal to be input into the modulation electrode of the optical waveguide device is provided inside the case.

11. An optical transmission apparatus comprising:
the optical modulation device according to claim 9; and
an electronic circuit that outputs a modulation signal causing the optical modulation device to perform a modulation operation.
